(19) United States
(12) Patent Application Publication
(10) Pub. No.: US 2016/0250542 A1
(43) Pub. Date: Sep. 1, 2016

(54) CURVED CHIPPING TOOL FOR NON-RESTRICTIVE TRAINING

(71) Applicants: Keith Daniel Petty, Farmington, MO (US); Tony Polus, SR., Farmington, MO (US)

(72) Inventors: Keith Daniel Petty, Farmington, MO (US); Tony Polus, SR., Farmington, MO (US)

(21) Appl. No.: 14/505,072

(22) Filed: Oct. 2, 2014

Related U.S. Application Data
(60) Provisional application No. 61/886,147, filed on Oct. 3, 2013.

(51) Int. Cl. A63B 69/36; G09B 19/00

(52) U.S. Cl. CPC A63B 69/3632; G09B 19/0038

(57) ABSTRACT

A golf swing training device attached to the top end of a golf club grip to help a golfer improve his swing. The device includes, among other things, a curved arm and a locking device for retaining the curved arm in a fixed position. The locking device is also operative for attaching the locking device to the top end of a golf club grip. When the locking device is attached to the golf club grip, the arm extends away from the golf club grip for a first distance and then curves toward the golfer for a second distance. During the golfer's swing, the curved arm contacts the golfer if the golf swing exhibits improper form, but remains away from the golfer if the golf swing exhibits proper form

### CROSS-REFERENCE TO RELATED APPLICATIONS

This application is a filing of the invention as a non provisional patent application and claims a cross reference to the provisional patent Application No. 61/886,147.

### STATEMENT REGARDING FEDERALLY SPONSORED RESEARCH

Not Applicable.

### APPENDIX

Not Applicable.

### BACKGROUND OF THE INVENTION

1. Field of the Invention

The present invention relates to golf training device, and more particularly to a curved tool attached or affixed to a golf club for improving a player's pitch/chip shot.

2. Related Art

Prior art training devices have been used by players to assist with improving their golf game. The prior art devices have traditionally been limited to straight extensions attached to the golf club grip. The devices, however, introduce incorrect golf club handling, as the straight extensions force the player's hands too far forward during address. This unnatural positioning of the hands would not be replicated during normal play without the extension, creating bad habits during address and execution of the pitch shot. These prior art devices do not teach proper form, as they instead introduce poor form into the player's golf experience. There is no golf training device that allows the player to maintain proper form while providing tactile feedback to the player.

Examples of known golf training devices are described in the references listed below, which are hereby incorporated by reference.

| | | | | |
|---|---|---|---|---|
| U.S. Pat. No. 4,145,054 | U.S. Pat. No. 4,170,356 | U.S. Pat. No. 4,582,325 | U.S. Pat. No. 4,595,204 | U.S. Pat. No. 4,819,944 |
| U.S. Pat. No. 5,152,533 | U.S. Pat. No. 5,167,415 | U.S. Pat. No. 5,234,217 | U.S. Pat. No. 5,427,376 | U.S. Pat. No. 5,524,892 |
| U.S. Pat. No. 5,689,080 | U.S. Pat. No. 5,759,110 | U.S. Pat. No. 5,890,977 | U.S. Pat. No. 6,022,278 | U.S. Pat. No. 6,196,930 |
| U.S. Pat. No. 6,921,340 | U.S. Pat. No. 7,637,821 | U.S. Pat. No. 7,789,765 | U.S. Pat. No. 8,128,507 | U.S. Pat. No. 8,241,138 |
| US 20090017931 | US 20090203459 | US 20110201439 | US 20120083354 | WO 94/007576 |
| WO 0/2070083 | | | | |

### SUMMARY OF THE INVENTION

In an embodiment of the present invention, a golf swing training device is attached to the top end of a golf club grip to help a golfer improve his swing, e.g., his chip and pitch swing. The device includes, among other things, a curved arm and a locking device for retaining the curved arm in a fixed position. The locking device is also operative for attaching the locking device to the top end of a golf club grip. When the locking device is attached to the golf club grip, the arm extends away from the golf club grip for a first distance and then curves toward the golfer for a second distance. During the golfer's swing, the curved arm contacts the golfer if the golf swing exhibits improper form, but remains away from the golfer if the swing exhibits proper form.

Further areas of applicability of the present invention will become apparent from the detailed description provided hereinafter. It should be understood that the detailed description and specific examples, while indicating the preferred embodiment of the invention, are intended for purposes of illustration only and are not intended to limit the scope of the invention.

### BRIEF DESCRIPTION OF THE DRAWINGS

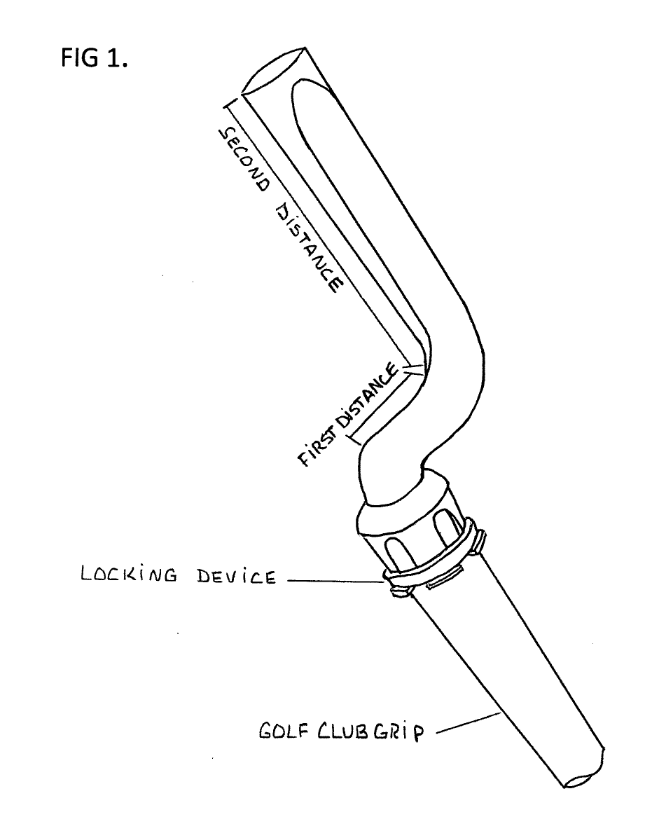

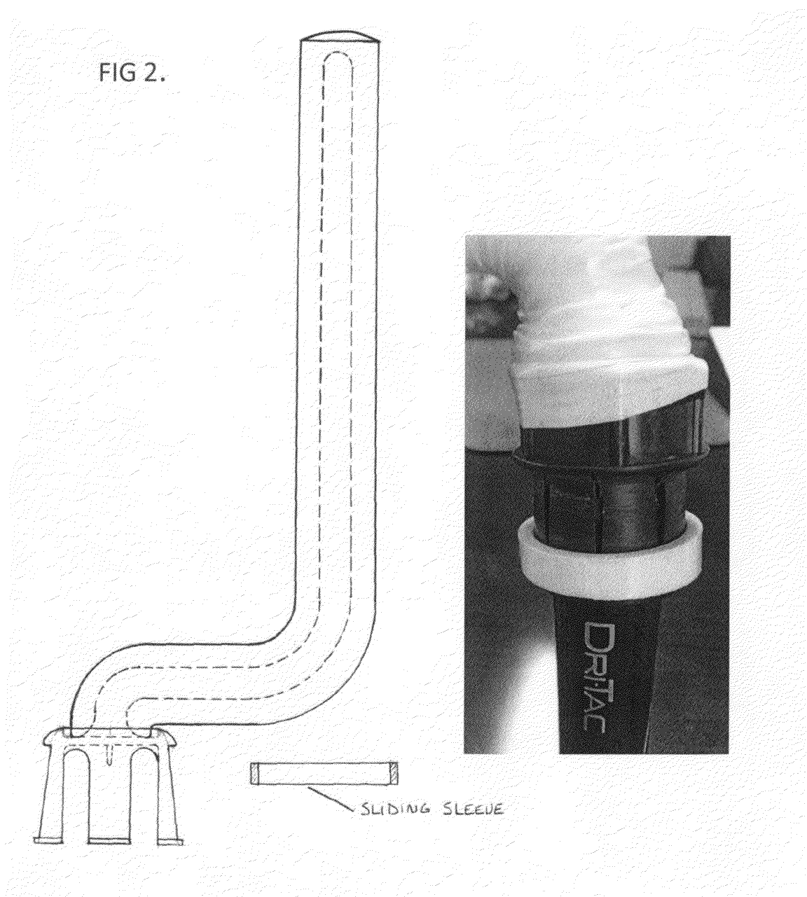

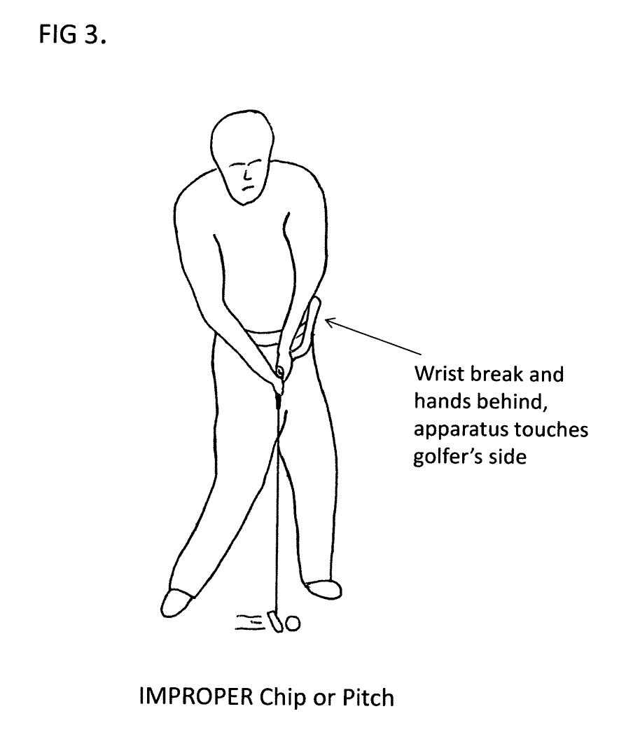

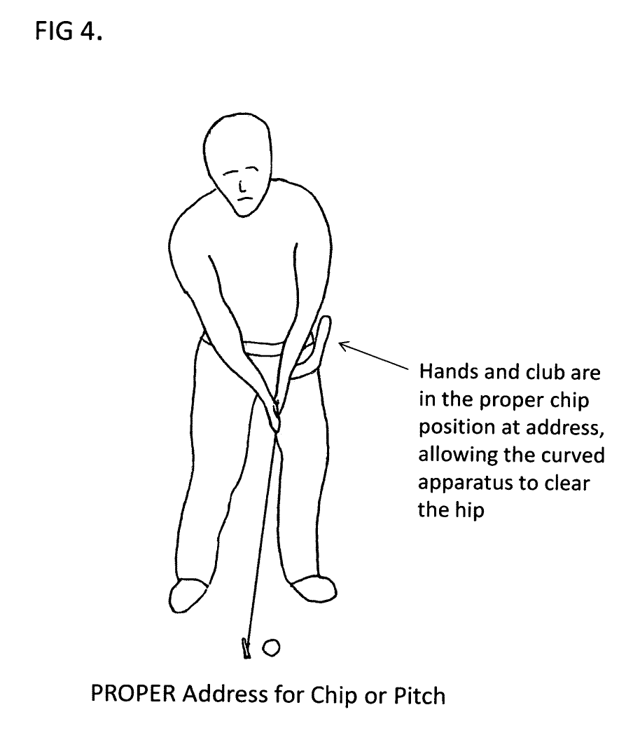

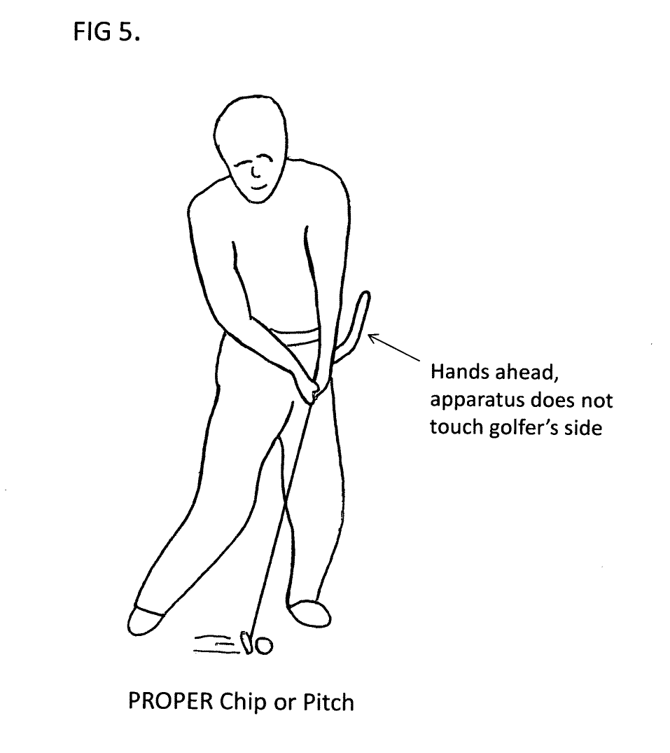

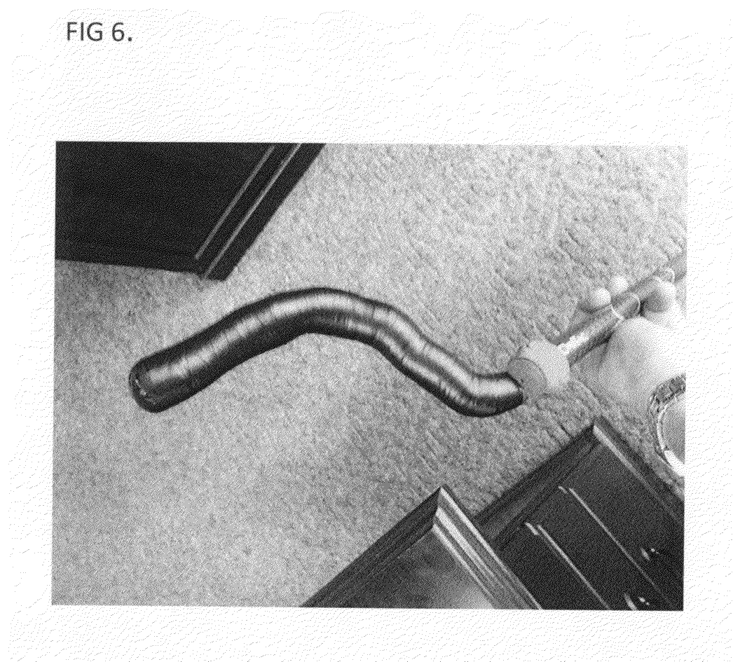

The present invention will become more fully understood from the accompanying nine (9) drawings including a simplified drawing of the exemplary golf swing training device, including a curved arm and a locking device, affixed or otherwise attached to a golf club in FIG. 1, a simplified drawing of the swing training device and locking device in FIG. 2, a drawing of an exemplary swing training device being utilized during an improper chip/pitch golf swing in FIG. 3, a drawing of an exemplary golf swing training device being utilized with a proper address for a chip/pitch golf swing in FIG. 4, a drawing of an exemplary golf swing training device being utilized during an proper chip/pitch golf swing in FIG. 5, and exemplary embodiments of a golf swing training device in FIGS. 6-10.

### DETAILED DESCRIPTION OF THE PREFERRED EMBODIMENTS

The following description of the preferred embodiment(s) is merely exemplary in nature and is in no way intended to limit the invention, its application, or uses.

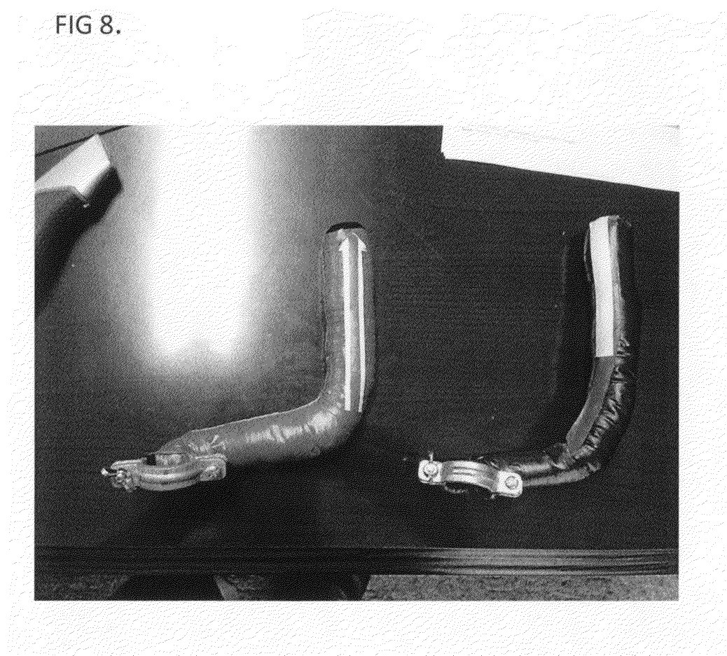

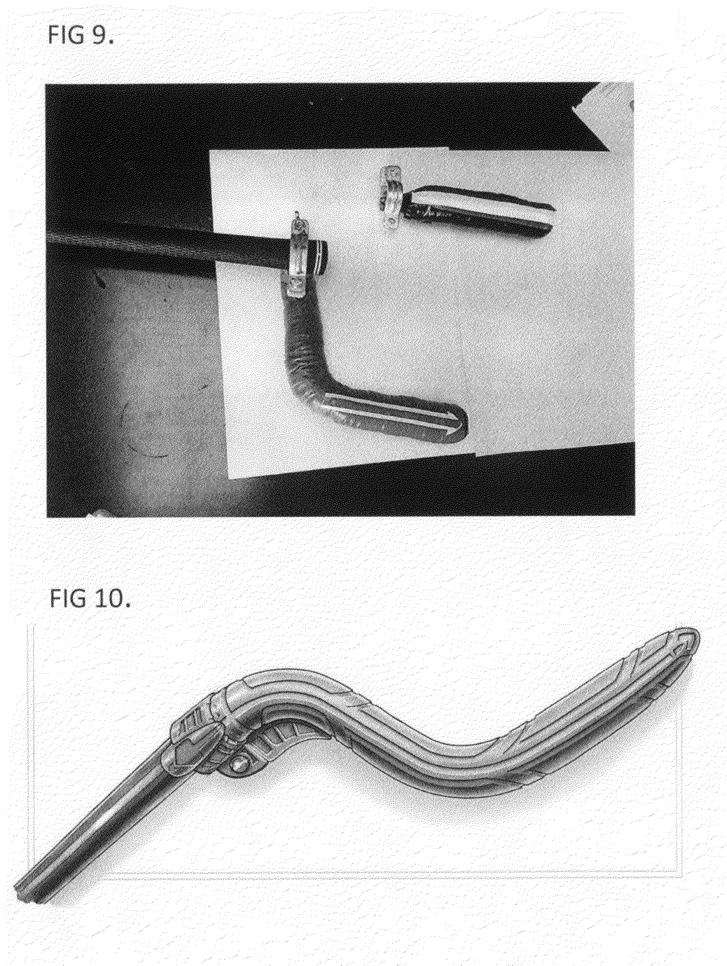

One embodiment of the present invention is a golf swing training device attached or otherwise affixed along the shaft of a golf club to help a golfer improve his swing. In some embodiments, the training device is attached to the top end of a golf club at the golf club grip, as illustrated in FIGS. 1, 2 and 6. In other embodiments, such as those illustrated in FIGS. 8 and 9, the training device is secured to the golf club at a point along the shaft.

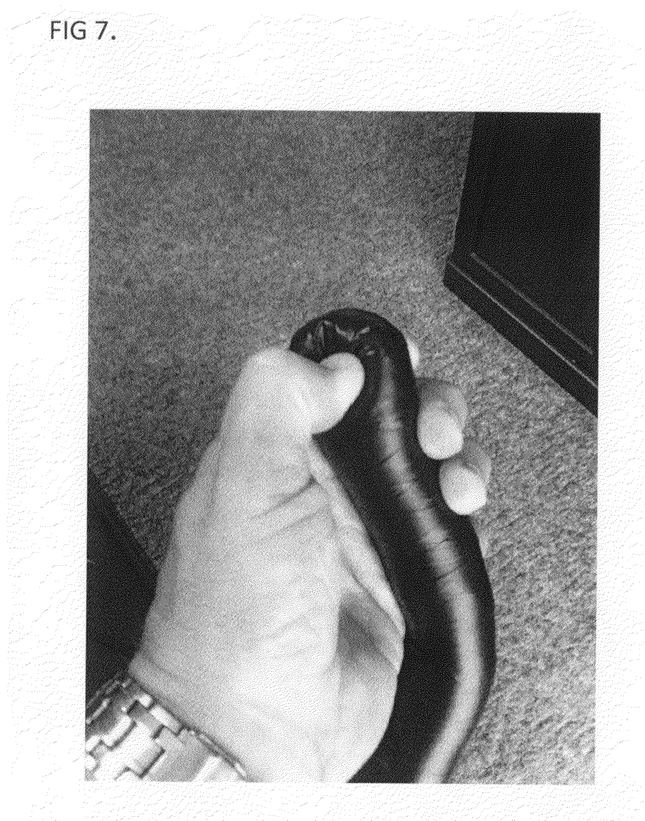

The device includes, among other things, a curved arm and a locking device for retaining the curved arm, with the locking device being operative for attaching the locking device and retaining curved arm to the top end of a golf club grip. FIGS. 1, 2 and 6 illustrate an exemplary curved arm and locking device. In some embodiments, the curved arm includes a soft, compressible material, as demonstrated in FIG. 7, disposed around a firm, pliable core for effectively altering the first distance and the second distance of the curved arm. This aspect of the present invention allows a golfer to adjust the training device for his specific body proportions. In other embodiments, the core is a fixed, non-pliable core. As illustrated in FIG. 2, the core may be a curved, flexible rod that allows for some bending when it contacts the golfer's side and then returns to its original unflexed position when the force is removed. One of ordinary skill in the art will recognize that many combinations of materials may be used without departing from the scope of the present invention.

In some embodiments, the locking device includes a top surface and one or more legs extending perpendicularly away from the longitudinal axis of the club's shaft proximal to the end of the shaft or at its top surface. The locking device further includes a sliding sleeve positioned around the legs that is movable along the length of the legs. The locking device is affixed to the golf club grip by sliding the sliding sleeve towards the top of the locking device, positioning the top of the golf club grip within the interior of the legs and then moving the sliding sleeve away from the top and along the length of the legs. The sliding sleeve creates a compressive force against the legs, which in turn push against the golf club grip with sufficient force to hold the locking device and curved arm in place. The training device is then considered affixed or otherwise attached to the golf club. Other means of attachment are within the scope of the present invention, such as a quick-attach/quick-release mechanisms, clamps that may be hinged on one side such as shown in FIG. 10 or have fasteners on both sides (pipe joint fittings as an example as shown in FIG. 9), and any other materials, device or construction that operatively attaches or affixes an arm to a golf club.

One of ordinary skill in the art will recognize that the curved arm may be retained by the locking device by any suitable means without departing from the scope of this invention, such as an adhesive placed between an end of the arm and a top surface of the locking device. For example, the curved arm may pass through an opening in the top surface of the locking device, where the end of the curved arm has a lip extending radially outward, where the radius of the lip is greater than the opening in the top surface of the locking device. When the locking device is affixed to the top of the golf grip, as illustrated in FIG. 1, the top of the grip presses against the lip of the curved arm and the locking device retains the curved arm in a fixed position.

Once the locking device is attached to the golf club grip in the appropriate position, the curved arm extends away from the golf club grip for a first distance and then curves toward the golfer for a second distance. In order to ensure the training device contributes to proper golfing technique, the first distance and second distance are determined by the physical characteristics of the golfer. For example, one embodiment of the curved arm may have a first distance and a second distance for a golfer of shorter stature, while a second embodiment of the curved arm may have a different first distance and a different second distance for a golfer of a larger stature. This configuration allows for the golfer's hands to be in proper position when addressing the ball and does not impede the golfer's play, as the training device curves around the golfer's body before the chip shot. In other words, unlike the prior art devices, the described training device does not force the golfer's hands too far forward at address, allowing the golfer to maintain natural, proper positioning.

When the golfer takes a shot with the training device attached to his club, the curved arm contacts the golfer if the golfer exhibits improper form during the chip or pitch swing, as demonstrated in FIG. 3. This is often due to the golfer rotating his wrists prior to the club clearing his hips, which contributes to inconsistent results. According to aspects of the present invention, the end of the curved arm or some portion of the curved arm “pokes” or “bumps” against the side of the golfer's torso when the golfer uses bad form while performing a chip shot, i.e., the curved arm provides the golfer with real-time tactile feedback regarding proper/improper form. During a chip/pitch swing exhibiting proper form, the golfer's hands remain ahead of the club and the curved arm remains away from the golfer's torso, such that the curved arm does not make contact with the golfer, as demonstrated in FIGS. 4 and 5. In other words, embodiments of the present invention provide a training tool that trains a golfer to keep his hands ahead of the club head until his hands clear his hips, otherwise the curved arm of the training device touches the golfer's side, providing instant feedback that the swing was incorrect.

In some embodiments, the curved arm, the locking device or both include one or more visual indicia for the golfer when swinging the golf club. For example, the visual indicia may include one or more of a reflective stripe or a powered light. These visual indicia may be used by the golfer to assist with proper positioning and proper form, or the visual indicia may be used by a third party to assess proper positioning and form. It is also within the scope of the present invention to have a computerized system utilize, monitor, and track the visual indicia, or some combination thereof, and report on the golf swing.

The embodiments were chosen and described to best explain the principles of the invention and its practical application to persons who are skilled in the art. As various modifications could be made to the exemplary embodiments, as described above with reference to the corresponding illustrations, without departing from the scope of the invention, it is intended that all matter contained in the foregoing description and shown in the accompanying drawings shall be interpreted as illustrative rather than limiting. Thus, the breadth and scope of the present invention should not be limited by any of the above-described exemplary embodiments, but should be defined only in accordance with the following claims appended hereto and their equivalents.

What is claimed is:

1. A golf swing training device for a golfer holding a golf club at a grip portion at a top end, the golf club having a shaft extending along a longitudinal axis from the top end toward a head at the bottom end of the club, the device comprising:
a curved arm having a first extension, a second extension and at least one bend between said first extension and said second extension, wherein said first extension is approximately at a right angle to said second extension through said bend; and
a locking device, said locking device retaining said first extension of said curved arm in a fixed position relative to the golf club, said locking device removably attaching said curved arm to the top end of the golf club grip;
wherein said first extension of said arm extends away from the golf club grip for a first distance in a first direction substantially perpendicular to the longitudinal axis of the shaft, and wherein said bend in said curved arm angles said second extension of said arm in an axis substantially parallel to the longitudinal axis of the club toward the golfer for a second distance.

2. The device of claim 1, wherein said arm is in contact with the golfer during a first golf swing exhibiting improper form, and wherein said arm remains out of contact from the golfer during a second golf swing exhibiting proper form.

3. The device of claim 1, wherein said arm comprises one or more visual indicia for the golfer when swinging the golf club.

4. The device of claim 1, wherein said first extension and said second extension are approximately equal in length and a substantially shorter segment than said first extension extends along the longitudinal axis between said locking device and said first extension.

5. The device of claim 1, Wherein said second extension is approximately equal to or greater than the first extension.
